(19) United States
(12) Patent Application Publication
(10) Pub. No.: US 2023/0335825 A1
(43) Pub. Date: Oct. 19, 2023

(54) SYSTEMS AND METHODS FOR BATTERY ENERGY SYSTEM STORAGE CONTROL

(71) Applicant: Carrier Corporation, Palm Beach Gardens, FL (US)

(72) Inventors: Karl Fredrik Penden, Rumford, RI (US); John Curtis Kliem, Wayland, MA (US)

(21) Appl. No.: 18/301,207

(22) Filed: Apr. 14, 2023

Related U.S. Application Data
(60) Provisional application No. 63/363,116, filed on Apr. 18, 2022.

(51) Int. Cl. H01M 10/633

(52) U.S. Cl. CPC H01M 10/633

(57) ABSTRACT

Systems and methods for battery energy storage system (BESS) control are disclosed. In some embodiments, a system comprises at least one processor; and memory storing instructions executable by the at least one processor, the instructions when executed cause the system to: obtain information related to one or more environmental parameters of the BESS; and generate a recommendation based on the environmental parameters, the recommendation indicating whether to access the BESS.

### CROSS REFERENCE TO A RELATED APPLICATION

The application claims the benefit of U.S. Provisional Application No. 63/363,116 filed Apr. 18, 2022, the contents of which are hereby incorporated in their entirety.

### BACKGROUND

The invention relates generally to battery energy storage systems (BESS) and, more specifically, to BESS control.

Current battery energy storage systems (BESS) may monitor temperature, battery status, charging status, etc. The fire protection system generally monitors heat, smoke, and manual relay inputs. A typical system may at most alert a first responder to system alarm and discharge status but does not indicate whether the atmosphere is safe for entry.

### BRIEF DESCRIPTION

Aspects of the disclosure relate to methods, apparatuses, and/or systems for BESS control.

In some embodiments, a system for battery energy storage system (BESS) control comprises at least one processor; and memory storing instructions executable by the at least one processor, the instructions when executed cause the system to: obtain information related to one or more environmental parameters of the BESS; and generate a recommendation based on the environmental parameters, the recommendation indicating whether to access the BESS.

In some embodiments, the system may be configured to control an access control device of the BESS based on the environmental parameters.

In some embodiments, the system may be configured to lock the access control device responsive to the one or more environmental parameters reaching a parameter threshold.

In some embodiments, the environmental parameters comprise a level of one or more gases inside the BESS.

In some embodiments, the system may be configured to lock the access control device responsive to the level of one or more gases inside the BESS reaching a gas level threshold.

In some embodiments, the system may be configured to obtain information related to presence of an individual in the vicinity of the BESS; and lock the access control device based on the presence information.

In some embodiments, a method being implemented in a system comprising at least one processor, and memory storing instructions. The method comprises: obtaining information related to one or more environmental parameters of the BESS; and generating a recommendation based on the environmental parameters, the recommendation indicating whether to access the BESS.

In some embodiments, a non-transitory computer-readable storage medium storing program instructions computer-executable to implement: obtaining information related to one or more environmental parameters of the BESS; and generating a recommendation based on the environmental parameters, the recommendation indicating whether to access the BESS.

Various other aspects, features, and advantages of the invention will be apparent through the detailed description of the invention and the drawings attached hereto. It is also to be understood that both the foregoing general description and the following detailed description are examples and not restrictive of the scope of the invention.

### BRIEF DESCRIPTION OF THE DRAWINGS

FIG. 1 shows an example of a system for battery energy storage system (BESS) control, in accordance with one or more embodiments.

FIG. 2 shows an example BESS, in accordance with one or more embodiments.

FIG. 3 shows a flow diagram illustrating an exemplary BESS control method, in accordance with one or more embodiments.

FIG. 4 shows an example of a computer system that may be used to implement aspects of the techniques described herein.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

The present disclosure, in accordance with some embodiments, describes a system 100 for battery energy storage systems (BESS) control. In some embodiments, system 100 may be configured to provide information related to environmental parameters of the BESS (e.g., inside and/outside of the BESS). Particularly, system 100 may be configured to determine and/or communicate presence of hazardous conditions inside the BESS (e.g., explosive constituents, smoke, heat, flame, gases, suppressant concentration, oxygen levels, etc.) In some embodiments, system 100 may be configured to generate alerts or recommendations indicating presence of the hazardous conditions. The alerts/recommendations may be sent to a computing device (e.g., a user device) and/or displayed on a display of the BESS. In some embodiments, determination and/or communication of presence of hazardous conditions may help prevent the protected space inside the BESS from being disrupted during inerting or suppression by letting oxygen in and letting suppressing atmosphere out. Additionally, system 100 may prevent an unintentional ignition source to access the interior of the BESS during untimely entry of the BESS.

It is envisioned that knowing the state of the hazard can help inform first responders and/or other users of the BESS on suitable actions to take. In some embodiments, system 100 may be configured to prevent entry to the BESS based on determination of presence of hazardous conditions inside the BESS. For example, system 100 may be configured to control an access control device for the BESS (e.g., a locking mechanism) based on presence of hazardous conditions inside the BESS. In some embodiments, system 100 may be configured to control one or more systems of the BESS based on detection of the hazardous conditions (e.g., HVAC systems, fire suppression systems, vents, fans, etc.). Furthermore, in some embodiments, system 100 may be configured to control an access control device (e.g., to prevent entry) and/or control operations of other systems of the BESS based on detecting presence of an individual in the vicinity of the BESS. For example, to prevent the individual from entering a hazardous environment inside the BESS, and/or to protect the individual from hazard that can result from normal operations of the other systems of the BESS (e.g., fire suppression systems). That said, not all embodiments necessarily provide all of these benefits, and some embodiments may provide other distinct advantages, which is not to suggest that any other feature described herein may not also be omitted in some embodiments.

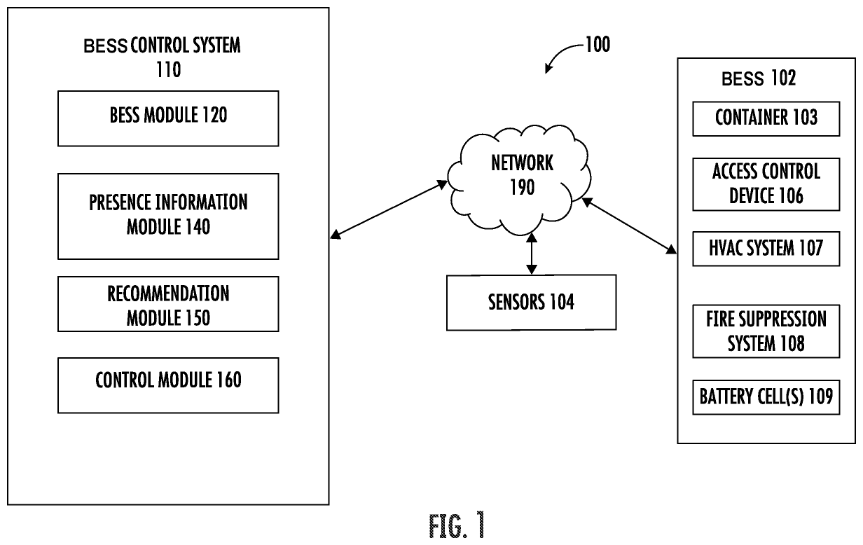

FIG. 1 shows a system 100 for a battery energy storage system (BESS) control, in accordance with one or more embodiments. In some embodiments, system 100 may include a BESS 102, one or more sensors 104, a BESS control system 110, and/or other components. Other components known to one of ordinary skill in the art may be included in system 100 to gather, process, transmit, receive, acquire, and provide information used in conjunction with the disclosed embodiments. In addition, system 100 may further include other components that perform or assist in the performance of one or more processes that are consistent with disclosed embodiments.

In some embodiments, BESS 102 may be a storage system configured for storing energy received from external power sources. In some embodiments, BESS 102 may include one or more of a battery cell 109, a heating ventilation and air conditioning (HVAC) system 107, a fire suppression system 108, and/or other components. In some embodiments, one or more of BESS components may be housed within housing 103. In some embodiments, BESS 102 may include an entry point (e.g., a door of housing 103) for allowing access inside BESS 102. In some embodiments, BESS 102 may include an access control device 106 configured for controlling access to BESS 102. FIG. 2 shows an example of a BESS 102 having a housing 103, a door 105, and an access device 106. In some embodiments, access control device 106 may control access to an area where BESS 102 is located (e.g., a building, a room, etc.).

It is to be noted that the BESS systems described herein are examples and not restrictive of the scope of the invention. Other types of energy storage systems may be used and are consistent with the present disclosure. For example, in some embodiments, BESS 102 may refer to a single battery, or single cell battery system. Furthermore, in some embodiments, the HVAC, fire suppression system, and/or other components described herein may be located outside of BESS 102. In some embodiments, BESS 102 does not include a housing (or container). In some embodiments, entering BESS 102 may refer to accessing the BESS and/or accessing an area where the BESS is located (e.g., in cases where the BESS is not housed in a container).

In some embodiments, one or more sensors 104 may be configured to generate output signals related to environmental parameters of BESS 102 (e.g., inside, and/or outside BESS 102). For example, the one or more signals may be related to temperature, pressure, humidity, air flow, smoke, gas concentration, flame, fluid levels, suppressant concentration, and/or other environmental parameters inside or outside BESS 102. In some embodiments, the environmental parameters may include parameters related to battery cell(s) 109. For example, temperature of the battery cell(s), heat generated by the battery cell(s), exhaust material from the battery cell(s), and/or other environmental parameters within the battery cell(s) or in the environment of the battery cell(s)). In some embodiments, sensors 104 may include one or more gas particle detectors configured to generate output signals related to levels (or concentration) of one or more gases inside or outside BESS 102. For example, these gases may include non-reactive, reactive, flammable, ignitable, combustible, or other types of gases. In some embodiments, sensors 104 may include one or more of smoke detectors, temperature sensors, flame detectors, gas particles detectors, pressure sensors, humidity sensors, air flow sensors, fluid sensors, position sensors, optical sensors, movement detectors, image sensors, and/or other sensors for measuring parameters related to the environment of BESS 102. In some embodiments, sensors 104 may be disposed in a plurality of locations. For example, inside or outside BESS 102, or directed at BESS 102 (e.g., optical sensors or cameras). In some embodiments, one or more of sensors 104 may be included in one or more components within or outside system 100 (e.g., in one or more of battery cell(s), battery racks, HVAC systems, fire suppression systems, access devices, etc.). In some embodiments, these components may be configured to provide some or all of the processing capabilities to the one or more sensors and/or communicate sensor data to BESS control system 110. In some embodiments, as explained below, the output signals from sensors 104 may be used to detect and/or determine presence of hazardous conditions inside or in the vicinity of BESS 102.

In some embodiments, sensors 104 may be configured to generate output signals conveying information related to one or more components of BESS 102 (e.g., status, condition, operating parameters, and/or operations of one or more of container 103, access control device 106, HVAC systems 107, fire suppression systems 108, battery cell(s) 109, etc.) For example, in some embodiments, sensors 104 may be configured to generate output signals related to the status of vents, doors, fans, access control devices, and/or other components of container 103.

In some embodiments, sensors 104 may be configured to generate output signals conveying information related to presence of an individual in the vicinity BESS 102 (e.g., within a distance of BESS 102). As explained below, information about presence of individuals in the vicinity of BESS 102 may be used (alone or in combination with information about presence of hazardous conditions) to generate recommendations and/or control operations of one or more components of system 100. For example, in some embodiments, sensors 104 may include optical sensors configured to generate one or more image data that may be used to detect individuals (e.g., images, videos, multi-dimensional depth images, thermal images, infrared light measurements, light reflection time measurements, radio wave measurements, range, angle, and/or other sensor data). In some embodiments, sensors 104 may include one or more of video camera, thermographic sensor, a depth sensor, a scanner, a LIDAR sensor, a RADAR sensor, a 3D camera, an infrared light sensor, a hyperspectral imager, multispectral imager, and/or other sensors. In some embodiments, sensors 104 may include wireless signal readers configured for detecting wireless signals emitted or transmitted by a user device belonging to an individual. For example, sensors 104 may be configured to wireless signals (e.g., (e.g., RF, NFC, BLE, BTLE, Wi-Fi, Ultra-wideband (UWB), or other wireless communications technologies) emitted by one or more user devices. The wireless signals may be used, in some embodiments, to determine presence of the individual. It is to be understood that sensors 104 described here are not intended to be limiting, other types of sensors may be used and are consistent with the present disclosure. For example, in some embodiments, sensors 104 may include one or more of an accelerometer, a location sensor, a global positioning system (GPS) sensor, a position sensor, a pedometer, a motion detector, an audio sensor, gas sensors, or other sensors for providing presence related information.

In some embodiments, information related to presence of individuals in the vicinity of BESS 102 may be obtained from other components within or outside of system 100. In some embodiments, these components may be configured to provide some or all of the processing capabilities to the one or more sensors and/or communicate sensor data to BESS control system 110. In some embodiments, access control information (e.g., obtained from access control device 106 or access control systems) may be used to determine presence of an individual near BESS (e.g., access events, RFID readings, etc.). For example, in some embodiments, system 100 may be configured to receive presence of individuals information from one or more access control devices used for controlling access to the space where BESS is located (e.g., access control devices for a door, a structure, a building, etc.). In some embodiments, one or more sensors 104 (described herein) may be included in an access control device. For example, one or more of an optical sensor, an RF reader, a biometric reader, a proximity sensor, motion sensor, and/or other sensors may be included in an access control device.

Fire suppression system 108 may be configured to control fire conditions in BESS 102. In some embodiments, fire suppression system 108 may be configured to inert and/or suppress exhaust material (e.g., gases, liquids, and/or solids) released from the one or more batteries within BESS 102. In some embodiments, fire suppression system 108 may be an inerting and/or suppression system configured to control fire conditions in BESS 102 based on output signals from one or more sensors (e.g., responsive to detection of smoke, exhaust material, flames, heat, fire, explosion, and/or other fire conditions within BESS 102). In some embodiments, fire suppression system 108 may include one or more of sensors 104 described above (e.g., smoke, flames, temperature, fire, pressure, gas detectors, an/or other sensors). In some embodiments, fire suppression system 108 may include one or more delivery devices (e.g., fire extinguishers, piping, nozzles, etc.) arranged in one or more areas of BESS 102. In some embodiments, fire suppression system may be configured to control one or more of the delivery devices to inert the exhaust materials responsive to detection of smoke, flames, heat, fire, explosion, and/or other fire conditions within their respective areas. Such operations of fire suppression system 108 may help mitigate fire conditions in specific areas of BESS 102 while preventing the spread of the fire conditions into other areas (e.g., battery cell(s) 109).

In some embodiments, operations of fire suppression system 108 may be controlled based on information from sensors 104, and/or information from other components of system 100 (as described herein below). For example, in some embodiments, fire suppression system 108 may be configured to control fire conditions in BESS 102 based on information related presence of an individual near BESS 102. In some embodiments, fire suppression system 108 may include a control system or may be controlled by control systems from other components within or outside system 100 (e.g., control module 160 described herein below).

In some embodiments, HVAC system 107 may be configured to control one or more air parameters inside BESS 102 (e.g., flow, temperature, humidity, and/or other air parameters inside BESS 102). In some embodiments, HVAC system 107 may be configured to control one or more air parameters based on output signals from one or more sensors (e.g., sensors 104). In some embodiments, one or more of sensors 104 may be included in HVAC system 107 (e.g., temperature, pressure, humidity, flow, gas, and/or other sensors). In some embodiments, operations of HVAC system 107 may be controlled based on information from sensors 104, and/or information from other components within or outside of system 100 (as described herein below). For example, in some embodiments, HVAC system 107 may be configured to control air parameters inside BESS 102 based on one or more of information related presence of an individual near BESS 102, information related to environmental parameters inside BESS, and/or other information from other components within or outside of system 100. In some embodiments, HVAC system 107 may include a control system or may be controlled by control systems from other components within or outside system 100 (e.g., control module 160 described herein below).

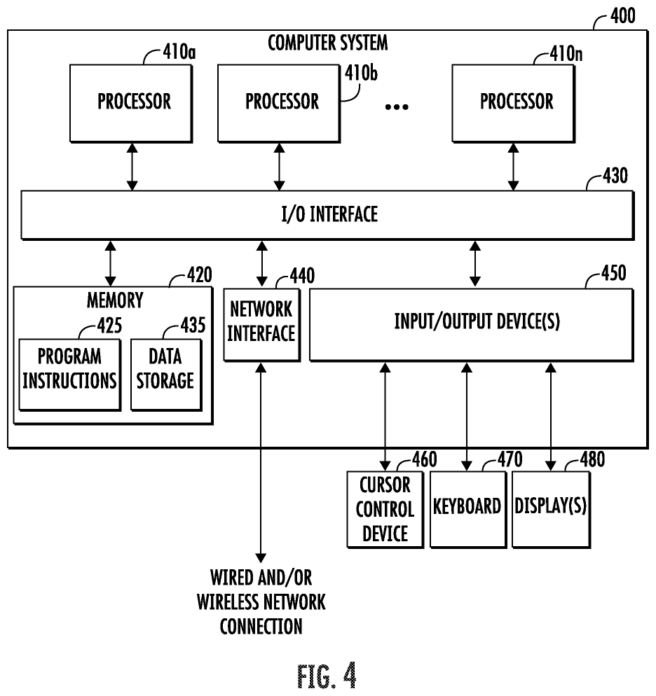

BESS control system 110 may include BESS information module 120, presence information module 140, recommendation module 150, control module 160, and/or other components. In some embodiments, BESS control system 110 may include computing resources such as processors and memory devices for storing instructions (e.g., computing system 400 described herein below with reference to FIG. 4). The processors may be configured to execute software instructions to perform various operations of system 100. The computing resources may include software instructions to perform operations of modules 110, 120, 140, 150, 160, and/or other components of system 100.

BESS information module 120, in some embodiments, may be configured to receive information related to environmental parameters of BESS 102. In some embodiments, BESS information module 120 may receive the environmental information from sensors 104, BESS 102, and/or other components within or outside system 100 (as described above). In some embodiments, BESS information module 120 may be configured to determine, based on information related to environmental parameters of BESS 102, one or more of a temperature, pressure, humidity, air flow, smoke, gas concentration, flame, fluid levels, suppressant concentration, and/or other environment parameters inside or outside BESS 102.

In some embodiments, BESS information module 120 may be configured to determine levels of one or more gases inside BESS 102. For example, these gases may include non-reactive, reactive, flammable, ignitable, combustible, or other types of gases. In some embodiments, BESS information module 120 may be configured to determine temperature inside BESS 102. For example, air temperature, battery cell(s) temperature, rack temperature, and/or temperature of other components of BESS 102). In some embodiments, BESS information module 120 may be configured to determine presence of explosive conditions (e.g., explosive gas combinations), lack of oxygen, suppressant concentration, and/or other hazardous conditions based on the output signals.

In some embodiments, BESS information module 120 may be configured to obtain information related to one or more components of BESS 102. For example, information related to HVAC system 107, Fire suppression system 108, battery cell(s) 109, and/or from other components within or outside of system 100 (e.g., data bases, storage, management systems, etc.) For example, in some embodiments, BESS information module 120 may be configured to obtain (or determine) status and/or operations of one or more components of BESS 102 (e.g., status, condition, operating parameters, and/or operations of one or more of container 103, access control device 106, HVAC systems 107, fire suppression systems 108, battery cell(s) 109, etc.) For example, in some embodiments, BESS information module 120 may be configured to obtain the status (e.g., open, closed, functioning, malfunctioning, etc.) of one or more of vents, doors, access control devices, and/or other components of container 103.

In some embodiments, BESS information module 120 may be configured to determine presence of hazardous conditions within or outside of BESS 102. For example, based on detected environmental parameters, and/or information related to one or more components of BESS 102. In some embodiments, BESS information module 120 may determine presence of hazardous conditions responsive to one or more environmental parameters reaching a parameter threshold value.

Presence information module 140, in some embodiments, may be configured to obtain information related to presence of an individual near BESS 102. In some embodiments, presence information module 140 may be configured to determine presence of an individual based on the obtained presence information. In some embodiments, presence information module 140 may be configured to determine presence of individuals based on information obtained from one or more components within or outside of system 100 (e.g., sensors 104, access device 106, an access control system, etc.). In some embodiments, presence information module 140 may be configured to determine a position and/or location of the individual relative to BESS 102. For example, in some embodiments, presence information module 140 may be configured to determine a distance of an individual from BESS 102.

In some embodiments, presence information module 140 may be configured to determine a likelihood of presence of an individual near BESS 102. For example, the likelihood of presence may be determined based on information related to the individual obtained from one or more of sensor information, access control device information, access control system information, or other information related to the individual. In some embodiments, the likelihood of the individual being present may increase or decrease based on the obtained presence information. For example, the likelihood of the individual being present may increase responsive to access events indicating that he has accessed the area (where the BES S is located) and hasn't exited yet. In some embodiments, the likelihood of the individual being present may increase responsive to an access control device detecting an access device (ID card), or access credentials, etc. In some embodiments, the likelihood of the individual being present may increase responsive to detection of wireless signals associated with his devices in the area where BESS is located. In some embodiments, the likelihood of the individual being present may decrease responsive to the access events indicating that the individual exited the area.

Recommendation module 150 may be configured to generate one or more recommendations based on obtained information from BESS information module 120 and/or presence information module 140. In some embodiments, the one or more recommendation may be in the form of a status of BESS 102 (e.g., a status of one or more components of BESS 102). In some embodiments, the one or more recommendations may include one or more recommended actions. For example, the recommendations/status may include environmental parameters information inside or outside BESS 102, status, condition, operating parameters, and/or operations of one or more components of system 100.

In some embodiments, the one or more recommendations may indicate an environment status within or outside BESS 102. For example, the one or more recommendations may indicate whether (or not) the environment of BESS 102 is safe to approach, access, enter, etc. In some embodiments, the recommendations may indicate hazardous conditions within or outside BESS 102 (e.g., present, likelihood of being present, and/or future prediction of hazardous conditions). In some embodiments, the recommendations may indicate the type of hazardous conditions (e.g., gas levels, suppressant level, toxic elements, etc.). In some embodiments, the recommendations may include information related to presence of individuals in the vicinity of BESS 102 (e.g., location of the individual as explained above).

In some embodiments, recommendation module 150 may generate one or more recommended actions based on the environment status, hazardous conditions, presence of individuals, and/or other BESS information. For example, in some embodiments, recommendation module 150 may generate a recommendation to not approach, access, open, and/or enter the BESS 102 (or to not unlock the access control device 106) based on information related to environmental parameters of BESS 102, information related to presence of an individual near BESS 102, the environment status, hazardous conditions status, etc. For example, the recommendation module 150 may generate a recommendation not to approach, access, unlock, or enter, BESS 102 based on determining that the BESS environment is unsafe, and/or determining presence of hazardous conditions.

In some embodiments, recommendation module 150 may be configured to generate a recommendation (e.g., to not approach, access, open, and/or enter) responsive to one or more environmental parameters reaching a threshold parameter. For example, recommendation module 150 may be configured to generate the recommendations responsive to a level of one or more gases inside BESS 102 reaching a predetermined threshold value. For example, these gases may include non-reactive, reactive, flammable, ignitable, combustible, or other types of gases. In some embodiments, recommendation module 150 may be configured to generate the recommendations responsive to temperature inside BESS 102 reaching a predetermined threshold temperature. Similarly, recommendation module 150 may be configured to generate the recommendations responsive to one or more or pressure, humidity, air flow, smoke, flame, fluid levels, battery temperature, battery exhaust, suppressant concentration, and/or other environment parameters reaching a respective predetermined threshold parameter.

In some embodiments, recommendation module 150 may be configured to generate one or more recommendations to control and/or adjust operating parameters for one or more components within or outside of system 100 (e.g., HVAC, fire suppression system, battery cell(s)/racks, vents, fans etc.) based on environmental information of BESS 102, environment status, hazardous conditions, BESS information, and/or presence information. In some embodiments, the recommendations may be sent directly to one or more components of system 100, to a user device, to a BESS management system, a building management system, and/or sent to other components of system 100. It is to be understood that the examples of recommendations given here are not intended to be limiting, other types of recommendations may be generated by system 100 and are consistent with the present disclosure. For example, the recommendations may include what type of action to take based on determined status or condition of the environment of BESS 102. For example, recommendations on how to mitigate unsafe or hazardous conditions based on the condition and/or the hazard.

In some embodiments, recommendations generated by recommendation module 150 may be displayed on a display (of the BESS, of a user device, of computing system 400 described herein, of a monitoring or management system, etc.). For example, BESS 102 may include a display 12 (shown in FIG. 2) configured to display the recommendations. In some embodiments, recommendation module 150 may be configured to display the recommendations on a user device 10 (shown in FIG. 2). In some embodiments, the recommendations may be in the form of an alert (e.g., visual, audible, text, graphical, etc.).

Control module 160 may be configured to control one or more operations of one or more components of system 100 based on information from BESS information module 120, presence information module 140, recommendation module 150, or from other components within or outside system 100. For example, in some embodiments, control module 160 may be configured to control one or more operations of one or more components of system 100 based on environmental information of BESS 102, environment status, hazardous conditions, BESS information, and/or presence information. In some embodiments, control module 160 may be configured to execute control commands received from BESS management systems, building management systems, user computing systems, etc.

For example, in some embodiments, control module 160 may be configured to control access control device 106 of BESS 102 based on environmental information of BESS 102, environment status, hazardous conditions, BESS information, and/or presence information. For example, in some embodiments, control module 160 may control operations of access control device 106 based on one or more of BESS information. In some embodiments, control module 160 may be configured to lock/unlock the access control device responsive to one or more environmental parameters reaching a threshold parameter. For example, control module 160 may be configured to lock the access control device responsive to a level of one or more gases inside BESS 102 reaching a predetermined threshold value. For example, these gases may include non-reactive, reactive, flammable, ignitable, combustible, or other types of gases. In some embodiments, control module 160 may be configured to lock the access control device responsive to temperature inside BESS 102 reaching a predetermined threshold temperature. Similarly, control module 160 may be configured to lock the access control device responsive to one or more or pressure, humidity, air flow, smoke, flame, fluid levels, suppressant concentration, and/or other environment parameters reaching a respective predetermined threshold parameter. In some embodiments, control module 160 may be configured to control operations of access control device 106 on determination of presence of hazardous conditions.

In some embodiments, control module 160 may control operations of access control device 106 based on presence information obtained from presence information module 140. In some embodiments, control module 160 may be configured to lock/unlock the access control device based on the presence information indicating presence and/or the likelihood of presence of an individual near BESS 102. For example, in some embodiments, control module 160 may be configured to lock the access control device responsive to the individual (or the likelihood of the individual) being within a predetermined threshold distance of BESS 102 (e.g., distance is equal or less than the predetermined threshold distance). In some embodiments, control module may unlock the access control device responsive to the distance being greater than the predetermined threshold distance. For example, in some embodiments, control module 160 may be configured to establish a geo fence around BESS 102, and responsive to detecting an individual (or the likelihood of the individual being) within the geo-fence lock the access control device of BESS 102. In some embodiments, control module 160 may unlock the access control device responsive to the individual (or the likelihood of the individual) being outside the established geo-fence.

In some embodiments, control module 160 may be configured to control and/or adjust operating parameters of one or more components of BESS 102 (E.G., the HVAC system 107, the fire suppression system 108, and/or the battery cell(s) 109, and/or other components) based on environmental information of BESS 102, environment status, hazardous conditions, BESS information, and/or presence information. For example, in some embodiments, control module 160 may be configured to control operations of one or more components of BESS 102 responsive to detection of an individual near BESS 102, and/or responsive to one or more environmental parameters reaching a parameter threshold. For example, in some embodiments, control module 160 may be configured to open, close, and/or adjust degree of opening of the vents based on detection of an individual and/or based on information from BESS information module 120. In some embodiments, control module 160 may activate or disactivate operations of the HVAC and fire suppression systems based on the environmental information of BESS 102, environment status, hazardous conditions, BESS information, and/or presence information. In some embodiments, control module 160 may be configured to control operations of one or more components of BESS 102 based on determination of presence of hazardous conditions (by BESS information module 120). In some embodiments, control module 160 may be configured to communicate control commands directly to individual control systems for the one or more components of system 100. In some embodiments, control module 160 may be configured to communicate control commands to a central control system for one or more components of system 100 (e.g., a BESS management system, or building management system).

In some embodiments, one or more components of system 100 may communicate directly through one or more dedicated communication links. In some embodiments system 100 may include a network 190 connecting one or more components of system 100. In some embodiments, network 190 may be any type of network configured to provide communications between components of system 100. For example, network may be any type of wired or wireless network (including infrastructure) that provides communications, exchanges information, and/or facilitates the exchange of information, such as the Internet, near field communication (NFC), optical code scanner, cellular network, a public switched telephone network (“PSTN”), text messaging systems (e.g., SMS, MMS), frequency (RF) link, Bluetooth®, Wi-Fi, a private data network, a virtual private network, a Wi-Fi network, a LAN or WAN network, or other suitable connections that enables the sending and receiving of information between the components of system 100. It will be appreciated that this is not intended to be limiting and that the scope of this disclosure includes implementations in which the client one or more components of system 100 are operatively linked via some other communication media.

It should be appreciated that the illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium.

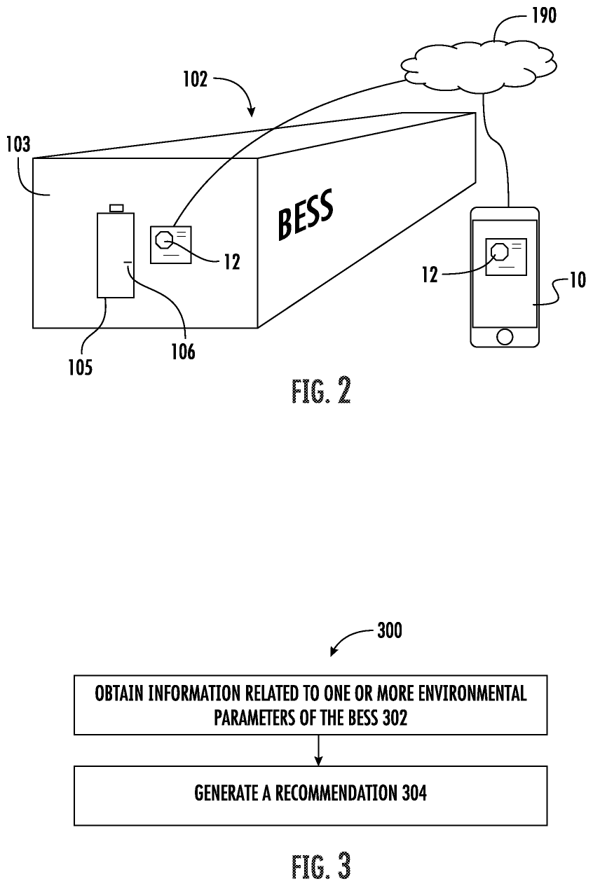

FIG. 3 illustrates a method 300 for BESS control, in accordance with one or more embodiments of the present disclosure. The operations of method 300 presented below are intended to be illustrative. In some implementations, method 300 may be accomplished with one or more additional operations not described and/or without one or more of the operations discussed. Additionally, the order in which the operations of method 300 are illustrated in FIG. 3 and described below is not intended to be limiting

In some embodiments, the methods may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on an electronic storage medium. The processing devices may include one or more devices configured through hardware, firmware, and/or software to be specifically designed for execution of one or more of the operations of the method.

At an operation 302 of method 300, information related to one or more environmental parameters of the BESS may be obtained. In some embodiments, operation 302 may be performed by a BESS information module the same as or similar to BESS information module 120 (shown in FIG. 1 and described herein).

At an operation 304 of method 300, recommendation indicating whether to access the BESS may be generated. In some embodiments, operation 304 may be performed by a recommendation module the same as or similar to recommendation module 150 (shown in FIG. 1 and described herein). It should be appreciated that the recommendation may be in the form of an automated response by the BESS (e.g., preventing access to the BESS, etc.), as described above.

Embodiments of one or more techniques of the present disclosure as described herein may be executed on one or more computer systems, which may interact with various other devices. One such computer system 400 is illustrated by FIG. 4. FIG. 4 shows an example of a computer system that may be used to implement aspects of the techniques described herein. In different embodiments, computer system 400 may include any combination of hardware or software that can perform the indicated functions, including, but not limited to, a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or other type of computing or electronic device.

In the illustrated embodiment, computer system 400 includes one or more processors 410 coupled to a system memory 420 via an input/output (I/O) interface 430. Computer system 400 further includes a network interface 440 coupled to I/O interface 430, and one or more input/output devices 450, such as cursor control device 460, keyboard 470, and display(s) 480. In some embodiments, it is contemplated that embodiments may be implemented using a single instance of computer system 400, while in other embodiments multiple such systems, or multiple nodes making up computer system 400, may be configured to host different portions or instances of embodiments. For example, in one embodiment some elements may be implemented via one or more nodes of computer system 400 that are distinct from those nodes implementing other elements.

In various embodiments, computer system 400 may be a uniprocessor system including one processor 410, or a multiprocessor system including several processors 410 (e.g., two, four, eight, or another suitable number). Processors 410 may be any suitable processor capable of executing instructions, and may include one or more semiconductor(s) and/or transistors (e.g., electronic integrated circuits (ICs)). In such a context, processor-executable instructions may be electronically executable instructions. For example, in various embodiments, processors 410 may be general-purpose or embedded processors implementing any of a variety of instruction set architectures (ISAs), such as the x86, PowerPC, SPARC, or MIPS ISAs, or any other suitable ISA. In multiprocessor systems, each of processors 410 may commonly, but not necessarily, implement the same ISA.

In some embodiments, at least one processor 410 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the image processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others. In some embodiments, one or more computers may include multiple processors operating in parallel. A processor may be a central processing unit (CPU) or a special-purpose computing device, such as graphical processing unit (GPU), an integrated circuit or on-chip system, an application-specific integrated circuit (ASIC), a field-programmable gate array (FPGA), a complex programmable logic device (CPLD), or application-specific integrated circuits.

System memory 420 may be configured to store program instructions and/or data accessible by processor 410. In various embodiments, system memory 420 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing desired functions, such as those described in this disclosure, are shown stored within system memory 420 as program instructions 425 and data storage 435, respectively. In other embodiments, program instructions and/or data may be received, sent or stored upon different types of computer-accessible media or on similar media separate from system memory 420 or computer system 400. Generally speaking, a computer-accessible medium may include storage media or memory media such as magnetic or optical media, e.g., disk or CD/DVD-ROM coupled to computer system 400 via I/O interface 430. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 440.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. In addition, in some embodiments some or all of the functionality of I/O interface 430, such as an interface to system memory 420, may be incorporated directly into processor 410.

Network interface 440 may be configured to allow data to be exchanged between computer system 400 and other devices attached to a network, such as other computer systems, or between nodes of computer system 400. In various embodiments, network interface 440 may support communication via wired or wireless general data networks, such as any suitable type of Ethernet network, for example, via telecommunications/telephony networks such as analog voice networks or digital fiber communications networks; via storage area networks such as Fibre Channel SANs, or via any other suitable type of network and/or protocol.

Input/output devices 450 may, in some embodiments, include one or more display terminals, cursor control devices (e.g., mouse), keyboards, keypads, touchpads, touchscreens, scanning devices, voice or optical recognition devices, or any other devices suitable for entering or retrieving data by one or more computer system 400. Multiple input/output devices 450 may be present in computer system 400 or may be distributed on various nodes of computer system 400. In some embodiments, similar input/output devices may be separate from computer system 400 and may interact with one or more nodes of computer system 400 through a wired or wireless connection, such as over network interface 440.

Those skilled in the art will appreciate that computer system 400 is merely illustrative and is not intended to limit the scope of the present disclosure. In particular, computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

What is claimed is:

1. A system for battery energy storage system (BESS) control, the system comprising:
at least one processor; and
memory storing instructions executable by the at least one processor, the instructions when executed cause the system to:
obtain information related to one or more environmental parameters of the BESS;
generate a recommendation based on the environmental parameters, the recommendation indicating whether to access the BESS; and
control an access control device of the BESS based on the environmental parameters.

2. The system of claim 1, wherein the instructions further cause the system to:
lock the access control device responsive to the one or more environmental parameters reaching a parameter threshold.

3. The system of claim 2, wherein the parameter threshold indicates an explosive/flammable condition inside the container.

4. The system of claim 1, wherein the environmental parameters comprise a level of one or more gases inside the BESS.

5. The system of claim 4, wherein the instructions further cause the system to:
lock the access control device responsive to the level of one or more gases inside the BESS reaching a gas level threshold.

6. The system of claim 1, wherein the instructions further cause the system to:
obtain information related to presence of an individual in the vicinity of the BESS; and
lock the access control device based on the presence information.

7. A method for battery energy storage system (BESS) control, the method being implemented in a system comprising at least one processor, and memory storing instructions, the method comprising:
obtaining information related to one or more environmental parameters of the BESS;
generating a recommendation based on the environmental parameters, the recommendation indicating whether to access the BESS; and
controlling an access control device of the BESS based on the environmental parameters.

8. The method of claim 7, further comprising:
locking the access control device responsive to the one or more environmental parameters reaching a parameter threshold.

9. The method of claim 8, wherein the parameter threshold indicates an explosive/flammable condition inside the container.

10. The method of claim 7, wherein
the environmental parameters comprise a level of one or more gases inside the BESS.

11. The method of claim 10, further comprising:
locking the access control device responsive to the level of one or more gases inside the BESS reaching a gas level threshold.

12. The method of claim 7, further comprising:
obtaining information related to presence of an individual in the vicinity of the BESS; and
locking the access control device based on the presence information.

13. A non-transitory computer-readable storage medium storing program instructions,
wherein the program instructions are computer-executable to implement:
obtaining information related to one or more environmental parameters of the BESS;
generating a recommendation based on the environmental parameters, the recommendation indicating whether to access the BESS; and
controlling an access control device of the BESS based on the environmental parameters.

14. The non-transitory computer-readable storage medium of claim 13, wherein the program instructions are computer-executable to implement:
locking the access control device responsive to the one or more environmental parameters reaching a parameter threshold.

15. The non-transitory computer-readable storage medium of claim 14, wherein the parameter threshold indicates an explosive/flammable condition inside the container.
